(19) United States
(12) Patent Application Publication
(10) Pub. No.: US 2005/0031149 A1
(43) Pub. Date: Feb. 10, 2005

(54) Echo-eliminating microphone

(76) Inventor: Birger Orten, Alesund (NO)

Correspondence Address: LADAS & PARRY LLP, 224 SOUTH MICHIGAN AVENUE, SUITE 1200, CHICAGO, IL, 60604, US

(21) Appl. No.: 10/497,802

(22) PCT Filed: Nov. 26, 2002
(86) PCT No.: PCT/NO02/00444

(30) Foreign Application Priority Data
Dec. 6, 2001 (NO) 2001 5982

(51) Int. Cl. H04R 9/08; H04R 17/02

(52) U.S. Cl. 381/355; 381/360

(57) ABSTRACT

A microphone (1) comprises a microphone housing (5), a sound-transducer (7) in a foremost part of the housing (15) and an inner space in the housing (5) behind the transducer (7), and there is provided a mechanical system (4, 8; 6) to provide variable ventilation for the inner space. Prefereably, the mechanical system is formed by an inner sleeve (8) that can be displaced by operating a knob (4).

The present invention relates to a microphone comprising a microphone housing, an acustoelectric transducer in a forward part of the housing for receiving sound from a sound emitter, an inner space in the housing behind the transducer, and equipment for transfer of sound-representing signals from the transducer, out from the microphone and to an external sound signal processing equipment.

Traditional microphones, particularly those used by song artists and similar, often exhibit some unfortunate characteristics regarding the conversion of received sound into electrical signals. The very microphone may contain some sources of error with a sound distorting effect For instance, a closed space inside the microphone will give rise to reflections and internal echoes, and this has an unfortunate influence on the quality of the sound-representing signals to be transmitted further on.

The present invention aims at remedying or reducing these problems of the prior art. Hence, to this purpose there is provided, in a first aspect of the invention, a microphone of the type mentioned above, and which is characterized in that the microphone housing includes a mechanical system for providing variable ventilation for the inner space.

In an important embodiment of the invention, the mechanical system is a system for choosing degree of closure/opening for a set of holes in the wall of the microphone housing behind the transducer. The mechanical system is then preferably constituted by a means for regulating distance between the transducer and a sleeve arranged behind the transducer and inside the wall of the microphone housing. The sleeve is preferably moveable in a forward direction toward the transducer by means of an operating knob located on the outside, thereby to close off a desired portion of the above mentioned holes.

Further, it is preferable that inside details in the microphone housing are covered by a sound-attenuating structure for providing sound reduction and avoidance of internal echoes.

The mechanical system may also comprise exchangeable front grilles in front of the transducer.

In accordance with a second aspect of the present invention, there is provided a microphone of the type stated in the introduction, and characterized in that the microphone housing has openings/holes in a wall surrounding the inner space, to provide ventilation for the inner space.

In a favourable embodiment of the microphone in accordance with the second aspect, the openings/holes are arranged in recessions in the wall inside a grid and with a shaping to ensure venting for the inner space also when a hand grips around the microphone in the area of the openings/holes.

In the following, the invention shall be illuminated further by discussing some none-limitative embodiments, and at the same time referring to the appended drawings, of which

FIG. 1 shows an embodiment of a microphone in accordance with the invention;

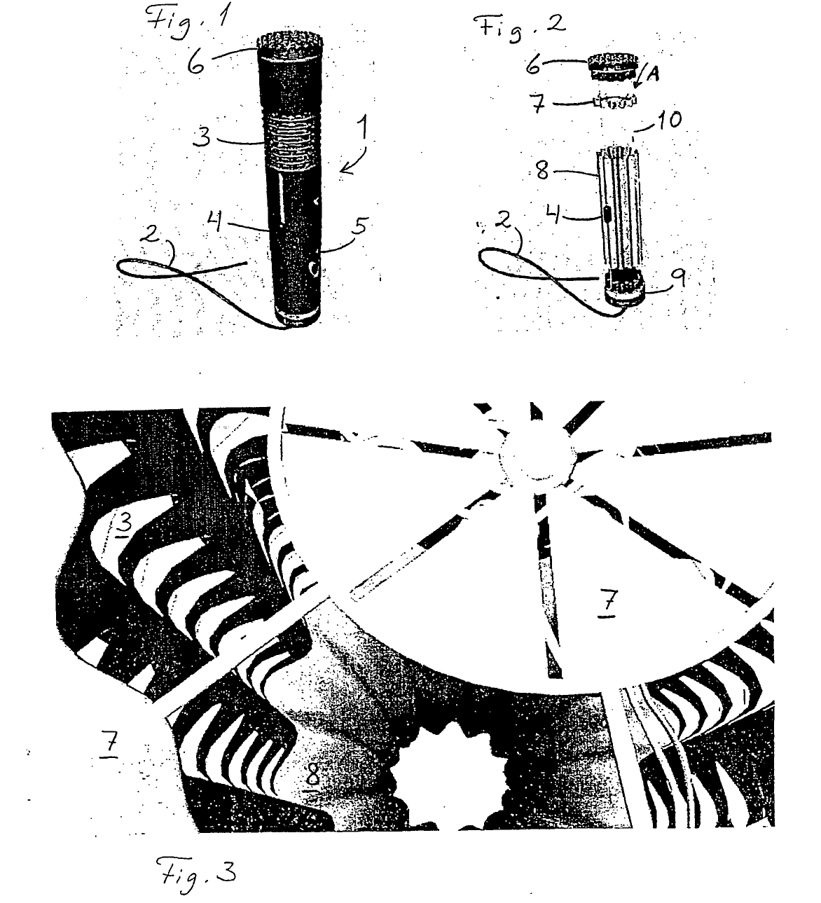

FIG. 2 shows the same microphone as in FIG. 1, however with the microphone housing removed so as to disclose internal parts;

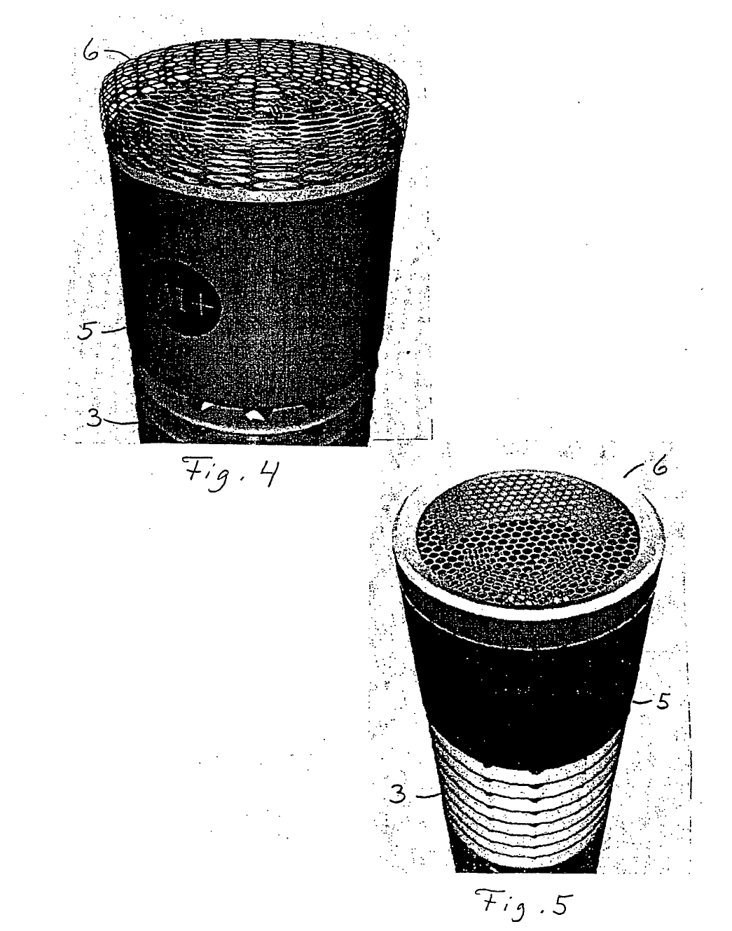

FIG. 3 is a perspective view showing the interior of the microphone in FIG. 2; and

FIGS. 4-8 show various types of front grille for the microphone in accordance with the invention.

In FIG. 1 appears an embodiment of a microphone 1 in accordance with the invention. The microphone is of a type having a wire connection 2 to external sound processing/amplifying equipment, but it may just as well be equipped with a base part having a radio transmitter and antenna. The microphone housing 5 constitutes a gripping part for the microphone, and extends substantially from base to top, but it has a section 3 in which a number of openings or holes are arranged all around the periphery. The holes/openings are arranged so as to be somewhat recessed inside a grid construction with “ribs” running peripherally and which provide for venting of air outward/inward even when a hand grips around this area. (In FIG. 3 appears an example of shaping of the holes, in an inside view.) At the top, i.e. closest to the sound emitter (which is for example the mouth of an artist using the microphone), there is a front grille of the grid type. At the side of the microphone housing, there is a slit with a knob 4.

In FIG. 2, the outer wall, i.e. the microphone housing 5, has been removed so as to show the parts inside. Underneath the front grille 6 there is a sound transducer 7, which in the embodiment shown, is of a type that is also mentioned in a co-filed Norwegian Patent Application No. 2001 5985 with title “Microphone”, from the same applicant. However, the special transducer type used is not important for the present invention, except that the transducer 7 itself may be of a type that provides a possibility for flow of air therethrough or not. In the first case, an air passageway through the microphone is defined thereby, and the air passageway starts with the front grille 6, continues in the space between the front grille and the transducer, further on through the transducer 7 and down into area 3 (FIG. 1) and outward through the holes/openings in this area.

A possibility for influencing this air passageway, i.e. to alter this passageway, is provided in the embodiment shown, by the provision that a sleeve 8 (FIG. 2) is equipped with a slide knob 4 that protrudes through the microphone housing 5, and can be moved along a slit in such a manner that sleeve 8 covers more and more of area 3, possibly until area 3 is completely covered.

There is of course a possibility also to have the opening area 3 altered by letting the very transducer element 7 slide downwards on its support rails 10 and relative to the upper part of microphone housing 5. The opening area 3 can be reduced also in this manner. (Possibly, the distance between sleeve 8 and transducer 7 can be maintained constant, i.e. so that both elements are moved in a connected state.)

FIG. 3 shows, in a perspective view, the interior of the microphone disclosed in FIG. 2, if an eye is placed to look in a direction such as indicated by arrow A in FIG. 2. However, to provide better contrast in the figure, the base part 9 has been removed in FIG. 3. Hence, one sees in the lowest part the inside of sleeve 8, thereabove appears the array of holes/openings in area 3, and at the top, closest to the eye, the transducer 7 that exhibits a flat central part of a circular type and with sector divisions, as well as stays extending out to a surrounding support rim, which is the element best seen in FIG. 2, but which is only partly shown at the far left in FIG. 3.

The moveable sleeve 8, upper surfaces of base part 9, as well as the grid parts of section 3 are coated with a sound-attenuating structure to provide a “sound-dead” internal space in the microphone. Also the geometry of the interior parts is designed with the same purpose. The sound-attenuating structure is provided by a sound-absorbing material like felt, rubber or wadding. A surface micro-structure with a repeated scale form can be used also.

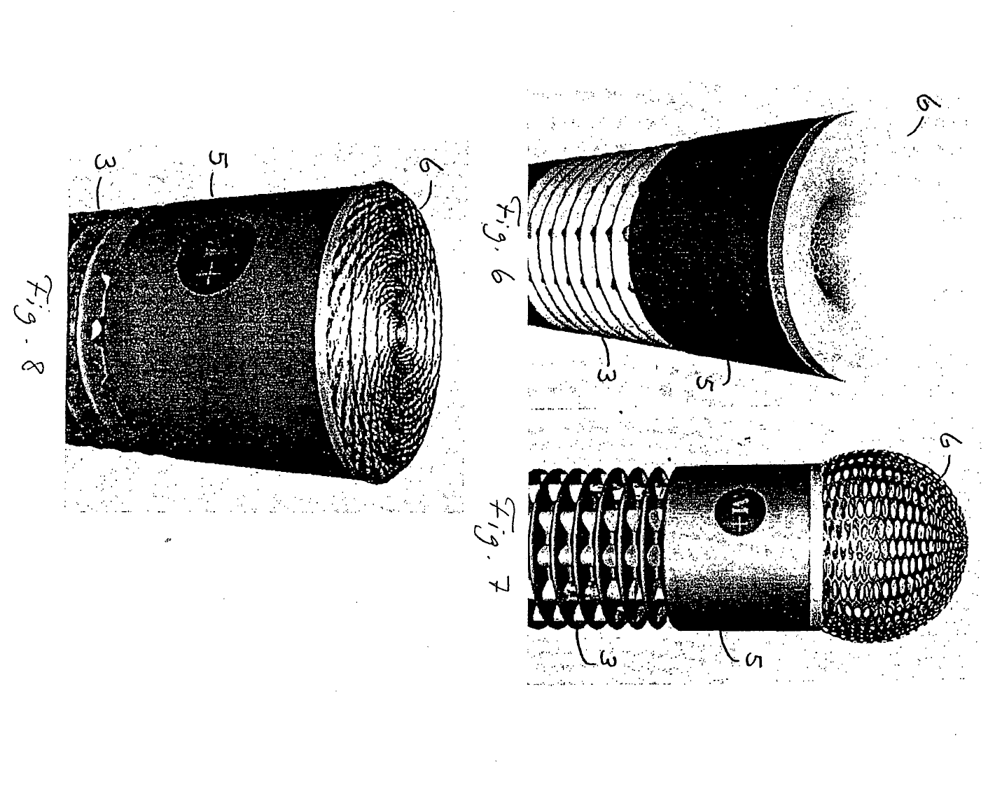

As mentioned above, the air passageway that is to be influenced, comprises also the front grille 6. In FIGS. 4-8 appear various exchangeable front grilles, i.e. in FIG. 4 appears the same type of front grille 6 as in FIG. 2, in FIG. 5 appears a front grille where the front netting is lowered toward the centre, in FIG. 6 appears a front grille having a lowered and funnel-shaped front surface and with a diminished netting surface down in the central recess, in FIG. 7 appears a ball-shaped front grille, and in FIG. 8 appears a front grille without a metal grid, only with a porous and sound-transparent material that may possibly have a sound filtering function. Each one of the front grilles shown here will provide a different air passageway downward and through the microphone, and can be selected in accordance with personal taste and in accordance with the sound parameters that are desired emphasized. The microphone user will, during testing, be able to determine which microphone tops/front grilles give the different sound results, and may thereafter change front grille as needed/desired. (It is also an important point with regard to hygiene, to be able to change microphone tops, in addition to the fact that a selection of tops also provides a possibility for changing style or “image” as desired.)

In the above description, only transducers 7 providing passage of air therethrough, have been discussed. But also in a case with a transducer that closes off the interior space at its forward end, it will be of interest to have a variable venting system in accordance with the invention. Without holes/opening area 3 in the housing wall, the microphone can be compared to a pressure chamber loudspeaker. The closed air volume in the interior space influences the ability of the transducer to vibrate, and locks the possibilities of correcting the transducer response. But with an air venting system in accordance with the present invention, i.e. for instance with the sleeve system as mentioned above, the degree of venting for the “rear space” will be adjustable as needed, from a pre-determined maximum opening and down to a completely closed state. Thereby the response of the microphone will be adjustable as desired.

Finally it shall be mentioned that the present invention is one of several inventions regarding a complete microphone, which inventions have been made the subject of simultaneous patent applications, and it is referred to Norwegian Patent Application No. 2001 5985 regarding “A microphone with ranging”, Norwegian Patent Application No. 2001 5983 regarding “A song microphone with signal processor equipment” and Norwegian Patent Application No. 2001 5984 regarding “A microphone with exchangeable details”. To the degree in which these co-filed applications exhibit features suitable to explain or complete features of the present invention, these applications are hereby incorporated in the present specification by reference.

1. A microphone comprising a microphone housing, an acustoelectric transducer in a forward part of the housing for receiving sound from a sound emitter, an inner space in the housing behind the transducer, and equipment for transfer of sound-representing signals from the transducer, out from the microphone and to an external sound signal processing equipment, c h a r a c t e r i z e d i n that said microphone housing includes a mechanical system for providing variable ventilation for the inner space.

2. The microphone of claim 1, c h a r a c t e r i z e d i n that the mechanical system is a system for choosing degree of opening/closure for a set of holes in the wall of the microphone housing behind the transducer.

3. The microphone of claim 2, c h a r a c t e r i z e d i n that the mechanical system is constituted by a device for regulating distance between the transducer and a sleeve arranged behind the transducer and inside the wall of the microphone housing.

4. The microphone of claim 3, c h a r a c t e r i z e d i n that the sleeve is moveable in a forward direction toward the transducer by means of an outside operating knob, thereby to close off a desired portion of said holes.

5. The microphone of claim 1, c h a r a c t e r i z e d i n that interior details in the microphone housing are covered by a sound-attenuating structure for providing sound attenuation and avoidance of internal echoes.

6. The microphone of any of the previous claims, c h a r a c t e r i z e d i n that the mechanical system also comprises exchangeable front grilles in front of the transducer.

7. A microphone comprising a microphone housing, an acustoelectric transducer in a forward part of the housing for receiving sound from a sound emitter, an interior space in the housing behind the transducer, and equipment for transfer of sound-representing signals from the transducer, out from the microphone and to an external sound signal processing equipment, c h a r a c t e r i z e d i n that the microphone housing has openings/holes in a wall that surrounds the interior space, to provide venting for the interior space.

8. The microphone of claim 7, c h a r a c t e r i z e d i n that the openings/holes are in recessions in the wall inside a grid construction, and having a shaping to ensure an air passageway to the interior space also when a hand grips around the microphone in the area of the openings/holes.
